(19) United States
(12) Patent Application Publication
(10) Pub. No.: US 2025/0192990 A1
(43) Pub. Date: Jun. 12, 2025

(54) AUTHENTICATION KEY EXCHANGE SYSTEM, EQUIPMENT, SERVER, METHOD, AND PROGRAM

(71) Applicant: NIPPON TELEGRAPH AND TELEPHONE CORPORATION, Tokyo (JP)

(72) Inventors: Kohei NAKAGAWA, Tokyo (JP); Akira NAGAI, Tokyo (JP); Yuki OKANO, Tokyo (JP); Atsushi FUJIOKA, Kanagawa (JP)

(21) Appl. No.: 18/842,181

(22) PCT Filed: Mar. 13, 2023
(86) PCT No.: PCT/JP2023/009707

§ 371 Date: Aug. 28, 2024

(30) Foreign Application Priority Data
Mar. 16, 2022 (JP) 2022-041306

(51) Int. Cl. H04L 9/08; H04L 9/32

(52) U.S. Cl. CPC H04L 9/0825; H04L 9/3268

(57) ABSTRACT

An authentication key exchange system according to one embodiment is an authentication key exchange system including a key generation device and a plurality of equipment. The key generation device includes a parameter generation unit configured to receive a security parameter 1^{λ} and a total number N of the equipment as inputs, and output a master private key MSK, a master public key MPK, and an initial revoked user list RL; a static private key generation unit configured to receive the master private key MSK, the master public key MPK, and an identifier ID of the equipment as inputs, and output a static private key ssk_{ID} corresponding to the identifier ID; a revoked user list update unit configured to receive the master public key MPK and a new revoked user list RL as inputs, increment a current time T, and update a revoked user list RL_{T} at the current time T to the revoked user list RL; and a key update information generation unit configured to receive the master private key MSK, the master public key MPK, the current time T, and the revoked user list RL as inputs, and output key update information ku_{T} at the current time T by using a KUNode algorithm. The equipment includes a latest private key generation unit configured to receive the master public key MPK, the static private key ssk_{ID} corresponding to its own identifier ID, and the key update information ku_{T} at the current time T as inputs, and output a latest private key csk_{ID,T} at the current time T without using pairing calculation; a temporary key generation unit configured to receive the master public key MPK and the latest private key csk_{ID,T} corresponding to its own identifier ID at the current time T as inputs, and output a temporary private key esk_{ID} and a temporary public key epk_{ID}; and a session key generation unit configured to receive the master public key MPK, its own identifier ID, an identifier ID′ of a communication partner, the latest private key csk_{ID,T} corresponding to its own identifier ID at the current time T, the temporary private key esk_{ID} corresponding to its own identifier ID, and a temporary public key epk_{ID′} corresponding to the identifier ID′ of the communication partner as inputs, and output a session key SK shared with the communication partner.

### TECHNICAL FIELD

The present invention relates to an authentication key exchange system, equipment, a server, a method, and a program.

### BACKGROUND

The authenticated key exchange (AKE) protocol is a protocol for each user to generate a common session key with a communication partner securely and reliably based on a user's own private key. The AKE protocol includes an ID-based AKE protocol using an ID (for example, a unique manufacturing number of equipment) as a public key, in addition to a public key infrastructure (PKI)-based AKE protocol using an electronic certificate. The ID-based AKE protocol has an advantage in comparison with the PKI-based AKE protocol in that it is not necessary to verify the association between the communication partner and the public key.

Additionally, the AKE protocol requires a user revocation function from the viewpoint of long-term operation. In the case of the PKI-based AKE protocol, validity/invalidity of a certificate can be checked by a validity period described in the certificate, but in the case of the ID-based AKE protocol, each user only knows the ID of the communication partner, and thus, there is no method of checking whether the ID or the private key of the communication partner is revoked. Therefore, in the existing ID-based AKE protocol (for example, Non-Patent Document 1), a user revocation function is realized by using a method in which a key generation center (KGC) distributes key update information to each user at regular intervals, and only valid users can acquire the latest private key from their own private key and the key update information.

### RELATED ART DOCUMENT

### Non-Patent Document

[Non-Patent Document 1] Tung-Tso Tsai, Yun-Hsin Chuang, Yuh-Min Tseng, Sen-Shan Huang, Ying-Hao Hung. “A Leakage-Resilient ID-Based Authenticated Key Exchange Protocol With a Revocation Mechanism”, 2021.

### SUMMARY OF THE INVENTION

### Problem to be Solved by the Invention

However, the existing ID-based AKE protocol with a revocation function has problems that it takes a linear time with respect to the number of users to generate key update information and that the calculation cost is high because pairing calculation is required.

In order to perform large-scale operation, it is necessary to reduce the time required to generate key update information, and it is expected that the ID-based key exchange is applied on equipment having a relatively small calculation resource, such as an IoT device, and thus it is desirable to perform a protocol at a lower calculation cost. Therefore, it is necessary to realize an ID-based AKE protocol with a revocation function in which the time required to generate key update information does not depend on the number of users and pairing calculation is not required.

An embodiment of the present invention has been made in view of the above, and it is an object to realize an ID-based AKE protocol with a revocation function in which the time required to generate key update information does not depend on the number of users and pairing calculation is not required.

### Means for Solving the Problem

To achieve the above-described object, an authentication key exchange system according to one embodiment is an authentication key exchange system including a key generation device and a plurality of equipment. The key generation device includes a parameter generation unit configured to receive a security parameter 1^{λ} and a total number N of the equipment as inputs, and output a master private key MSK, a master public key MPK, and an initial revoked user list RL; a static private key generation unit configured to receive the master private key MSK, the master public key MPK, and an identifier ID of the equipment as inputs, and output a static private key ssk_{ID} corresponding to the identifier ID; a revoked user list update unit configured to receive the master public key MPK and a new revoked user list RL as inputs, increment a current time T, and update a revoked user list RL_{T} at the current time T to the revoked user list RL; and a key update information generation unit configured to receive the master private key MSK, the master public key MPK, the current time T, and the revoked user list RL as inputs, and output key update information ku_{T} at the current time T by using a KUNode algorithm. The equipment includes a latest private key generation unit configured to receive the master public key MPK, the static private key ssk_{ID} corresponding to its own identifier ID, and the key update information ku_{T} at the current time T as inputs, and output a latest private key csk_{ID,T} at the current time T without using pairing calculation; a temporary key generation unit configured to receive the master public key MPK and the latest private key csk_{ID,T} corresponding to its own identifier ID at the current time T as inputs, and output a temporary private key esk_{ID} and a temporary public key epk_{ID}; and a session key generation unit configured to receive the master public key MPK, its own identifier ID, an identifier ID′ of a communication partner, the latest private key csk_{ID,T} corresponding to its own identifier ID at the current time T, the temporary private key esk_{ID} corresponding to its own identifier ID, and a temporary public key epk_{ID′} corresponding to the identifier ID′ of the communication partner as inputs, and output a session key SK shared with the communication partner.

### Effect of the Invention

An ID-based AKE protocol with a revocation function, in which the time required to generate key update information does not depend on the number of users and pairing calculation is not required, can be realized.

### BRIEF DESCRIPTION OF THE DRAWINGS

FIG. 1 is a diagram illustrating an example of an overall configuration of an ID-based authentication key exchange system according to the present embodiment.

FIG. 2 is a diagram illustrating an example of a functional configuration of a key generation device according to the present embodiment.

FIG. 3 is a diagram illustrating an example of a functional configuration of equipment according to the present embodiment.

FIG. 4 is a sequence diagram illustrating a flow from parameter generation to static private key generation in one embodiment.

FIG. 5 is a sequence diagram illustrating a flow from revocation list update to latest private key generation in one embodiment.

FIG. 6 is a sequence diagram illustrating a flow from temporary key generation to session key generation in one embodiment.

FIG. 7 is a diagram illustrating an example of a hardware configuration of a computer.

### DESCRIPTION OF THE EMBODIMENTS

In the following, an embodiment of the present invention will be described. In the embodiments described below, an ID-based authentication key exchange system 1 that realizes an ID-based AKE protocol with a revocation function in which the time required to generate key update information does not depend on the number of users and pairing calculation is not required will be described.

### <Preparation>

First, before describing the present embodiment, some symbols, concepts, algorithms, and the like are prepared.

Let λ be a security parameter, q be a prime power of a certain magnitude, and Z_{q}:=Z/qZ. Additionally, let {0,1}* be a binary sequence of an arbitrary length, and {0,1}^{λ} be a binary sequence of a λ bit length. Additionally, ∥ represents concatenation of bit strings.

### <<KUNode Algorithm>>

In many existing ID-based ciphers with revocation functions (for example, References 1 to 3 and the like), the time required to generate key update information is reduced by using a binary tree and the KUNode algorithm.

Let BT be a binary tree having leaves associated with IDs of users, RL be a list of leaves associated with IDs of revoked users, root be a root of the binary tree BT, Path(ID) be a set of nodes included in a path from a leaf associated with an ID to the root, x_{left} be a child node of a node x on the left side, and x_{right} be a child node of the node x on the right side.

In the above case, the KUNode algorithm includes the following step 1 to step 5.
Step 1: Let X=φ, Y=φ.
Step 2: For each ID∈RL, add Path(ID) to X.
Step 3: For each x∈X, add x_{left} to Y if x_{left} is not included in X, and add x_{right} to Y if x_{right} is not included in X.
Step 4: Add root to Y if Y=φ.
Step 5: Output Y.
   <<ID-based AKE Protocol with Revocation Function>>

The ID-based AKE protocol with the revocation function is configured by the following seven probabilistic polynomial time (PPT) algorithms. Here, a temporary key generation algorithm EKGen and a session key generation algorithm SKGen are symmetrical algorithms at an initiator and a responder, the algorithm on the initiator side will be described below on the assumption that the initiator has an identifier ID_{A} and the responder has an identifier ID_{B}. In the following description, ID_{A} and ID_{B} may be simply referred to as “A” and “B”, respectively. For example, in w_{ID}, r_{ID}, v_{ID}, and the like described later, when ID=ID_{A}, “w_{A}”, “r_{A}”, and “v_{A}” may be used, and when ID=ID_{B}, “w_{B}”, “r_{B}”, and “v_{B}” may be used.

ParGen(1^{λ},N)->(MSK,MPK,RL) is a parameter generation algorithm that takes a 1-bit string 1^{λ} having a length of the security parameter λ (this 1^{λ} may also be referred to as the security parameter) and the number N of users as inputs, and outputs a master private key MSK, a master public key MPK, and an initial revoked user list RL. The parameter generation algorithm ParGen is executed only once by the KGC. Here, although all the following algorithms also receive the master public key MPK as an input, for simplicity, the master public key MPK is omitted in the following description.

SSKGen(MSK,ID)->ssk_{ID} is a static private key generation algorithm that receives the master private key MSK and the identifier ID of the user as inputs, and outputs a static private key ssk_{ID} corresponding to the ID. The static private key generation algorithm SSKGen is executed by the KGC only once for each user.

Revoke(RL) is a revoked user list update algorithm that receives a new revoked user list RL as an input, increments the time T, and updates a revoked user list at the time T. The revoked user list update algorithm Revoke is executed by the KGC at regular intervals. Here, the revoked user list is a list of revoked identifiers ID.

KeyUp(MSK,T,RL)->ku_{T} is a key update information generation algorithm that receives the master private key MSK, the time T, and the revoked user list RL at the time as inputs, and outputs key update information ku_{T}. The key update information generation algorithm KeyUp is executed by the KGC at regular intervals.

CSKGen(ssk_{ID},ku_{T})->csk_{ID,T} is a latest-private key generation algorithm that receives the static private key ssk_{ID} and the key update information ku_{T} as inputs, and outputs the latest private key csk_{ID,T} or ⊥. The latest-private key generation algorithm CSKGen is executed by the user at regular intervals. Here, ⊥ indicates that the ID has been revoked.

EKGen(ID_{A},ID_{E},T,csk_{A,T})->(esk_{A},epk_{A}) is a temporary key generation algorithm that receives the identifier ID_{A} of the user, the identifier ID_{B} of a communication partner of the user, the current time T, and the latest private key csk_{A,T} of the user at the time T as inputs, and outputs a temporary private key esk_{A} and a temporary public key epk_{A} of the user in a session with the communication partner. The temporary key generation algorithm EKGen is executed by the user for each session.

SKGen(ID_{A},ID_{B},T,csk_{A,T},esk_{A},epk_{B})->SK is a session key generation algorithm that receives the identifier ID_{A} of the user, the identifier ID_{B} of the communication partner of the user, the current time T, the latest private key csk_{A,T} of the user at the time T, the temporary private key esk_{A} of the user, and the temporary public key epk_{B} of the communication partner as inputs, and outputs a session key SK. The session key generation algorithm SKGen is executed by the user for each session.

Here, the initiator and the responder of the session may use different algorithms as the temporary key generation algorithm EKGen and the session key generation algorithm SKGen.

In the present embodiment, as described later, the key update information generation algorithm KeyUp is configured using the KUNode algorithm. This can reduce the time required to generate the key update information. Additionally, as will be described later, the latest-private key generation algorithm CSKGen is configured using a signature called a Schnorr signature. This can eliminate the need for pairing calculation.

The Schnorr signature is an ID-based signature that does not use pairing calculation internally. More specifically, for each user, a signature is generated for a sentence (plain text) including information on the identifier ID and the time T by using, as a signature key, a value obtained by adding the static private key of the user and the key update information associated with the user, and the signature is used as the latest private key. Due to the properties of the signature, this latest private key can only be generated with the signature key, and thus only the user having the correct static private key and key update information can determine its value. Additionally, by using the property that a set of the correct signature, the plaintext, and the public key satisfies a certain equality, the same value can be calculated as a session key between users having the correct latest private keys.

### <Overall Configuration Example>

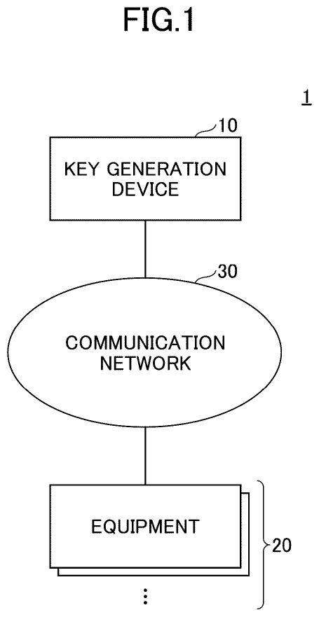

Next, an overall configuration example of the ID-based authentication key exchange system 1 according to the present embodiment will be described with reference to FIG. 1. FIG. 1 is a diagram illustrating an example of an overall configuration of the ID-based authentication key exchange system 1 according to the present embodiment.

As illustrated in FIG. 1, the ID-based authentication key exchange system 1 according to the present embodiment includes a key generation device 10 and multiple equipment 20. The key generation device 10 and the equipment 20 are communicably connected via a communication network 30. Similarly, the equipment 20 are communicably connected to each other via the communication network 30.

The key generation device 10 is a computer or a computer system that functions as a key generation center (KGC). The key generation device 10 executes the parameter generation algorithm ParGen, the static private key generation algorithm SSKGen, the revoked user list update algorithm Revoke, and the key update information generation algorithm KeyUp.

The equipment 20 is a computer or a computer system that performs authentication key exchange with another equipment 20. The equipment 20 executes the latest-private key generation algorithm CSKGen, the temporary key generation algorithm EKGen, and the session key generation algorithm SKGen.

As the equipment 20, for example, various terminals, equipment, devices, and the like, such as an IoT device, a smartphone, a tablet terminal, a personal computer (PC), a wearable device, an industrial device, an edge computer, and a general-purpose server can be used. For example, when the present embodiment is applied to a system that collects data from various IoT devices, it is conceivable that the equipment 20 on the initiator side may be the IoT device, and the equipment 20 on the responder side may be the edge computer or the like.

Hereinafter, when distinguishing between the multiple equipment 20, each individual equipment 20 is referred to using a designation such as “equipment 20A”, “equipment 20B”, and the like. Additionally, the following description assumes that the identifier ID of the equipment 20A is “ID_{A}”, the identifier ID of the equipment 20B is “ID_{B}”, the equipment 20A is the initiator, and the equipment 20B is the responder. Here, as the identifier ID, for example, a media access control (MAC) address, an Internet protocol (IP) address, a user ID, a mail address, a telephone number, or the like can be used in addition to a unique manufacturing number.

### <Functional Configuration Examples>

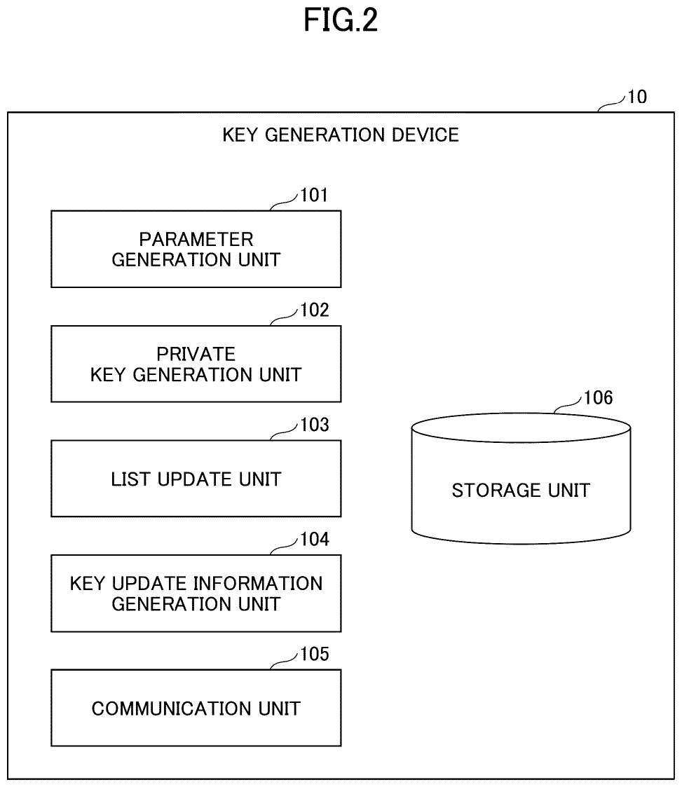

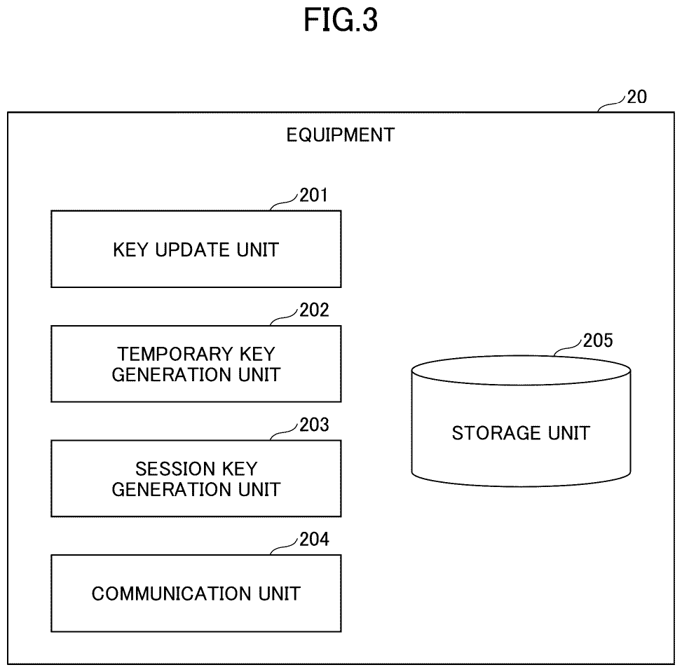

Next, functional configuration examples of the key generation device 10 and the equipment 20 according to the present embodiment will be described with reference to FIG. 2 and FIG. 3, respectively. FIG. 2 is a diagram illustrating an example of a functional configuration of the key generation device 10 according to the present embodiment. Additionally, FIG. 3 is a diagram illustrating an example of a functional configuration of the equipment 20 according to the present embodiment.

### <<Key Generation Device 10>>

As illustrated in FIG. 2, the key generation device 10 according to the present embodiment includes a parameter generation unit 101, a private key generation unit 102, a list update unit 103, a key update information generation unit 104, and a communication unit 105. These units are implemented by, for example, processing that one or more programs installed in the key generation device 10 cause a processor, such as a central processing unit (CPU), to execute. Additionally, the key generation device 10 according to the present embodiment includes a storage unit 106. The storage unit 106 is implemented by a storage device, such as a hard disk drive (HDD) or a solid state drive (SSD).

The parameter generation unit 101 executes the parameter generation algorithm ParGen. The private key generation unit 102 executes the static private key generation algorithm SSKGen. The list update unit 103 executes the revoked user list update algorithm Revoke. The key update information generation unit 104 executes the key update information generation algorithm KeyUp. The communication unit 105 performs various communications with the equipment 20 and the like. The storage unit 106 stores various data, results of various algorithms, calculation results obtained along the way, and the like.

### <<Equipment 20>>

As illustrated in FIG. 3, the equipment 20 according to the present embodiment includes a key update unit 201, a temporary key generation unit 202, a session key generation unit 203, and a communication unit 204. These units are implemented by, for example, processing that one or more programs installed in the equipment 20 cause a processor, such as a CPU, to execute. Additionally, the equipment 20 according to the present embodiment includes a storage unit 205. The storage unit 205 is implemented by a storage device, such as an HDD, an SSD, or a flash memory.

The key update unit 201 executes the latest-private key generation algorithm CSKGen. The temporary key generation unit 202 executes the temporary key generation algorithm EKGen. The session key generation unit 203 executes the session key generation algorithm SKGen. The communication unit 204 performs various communications with the key generation device 10 and another equipment 20. The storage unit 205 stores various data, results of various algorithms, calculation results obtained along the way, and the like.

### First Embodiment

In the following, a first embodiment will be described.

In the present embodiment, each algorithm of the ID-based AKE protocol with the revocation function is configured as follows. Here, in the present embodiment, the temporary key generation algorithm EKGen is configured to receive only the latest private key csk_{ID,T} as the input. Additionally, the temporary key generation algorithm EKGen and the session key generation algorithm SKGen are symmetric between the initiator and the responder, and thus with respect to the session key generation algorithm SKGen, the algorithm of the equipment 20A on the initiator side will be described below.
ParGen(1^{λ}, N)->(MSK,MPK,RL)
Step 1-1: Let q be a prime power of the size O(2^{λ}), G be a cyclic group of the order q, and g be a generator of G.
Step 1-2: Select x∈_{U}Z_{q} and set y=g^{x}.
Step 1-3: Set BT to be a binary tree having N leaves, and associate the IDs of the respective equipment 20 with the leaves.
Step 1-4: Prepare two hash functions H₁: {0,1}*×G->Z_{q} and H₂: G×G->{0.1}^{λ}.
Step 1-5: Output MSK=x, MPK=(q,G,g,y,BT,H₁,H₂), and RL=φ.

It should be noted that the master public key MPK is also used as the input in all the following algorithms, but the description thereof is omitted.
SSKGen (MSK, ID)->ssk_{ID}
Step 2-1: Select k∈_{U}Z_{q} and set r_{ID}=g^{k}.
Step 2-2: Set s_{ID}=k+xH₁(ID, r_{ID}).
Step 2-3: Output ssk_{ID}=(s_{ID}, r_{ID}).

It should be noted that the following equation is established.

$${g}^{{s}_{ID}} = {r}_{ID} \cdot {y}^{{H}_{1} ( ID , {r}_{ID} )} \qquad [ Equation 1 ]$$

KeyUp(MSK,T,RL)->ku_{T}
Step 3-1: For each θ∈KUNode(BT,RL), calculate (s_{T∥0},r_{T∥0})<-SSKGen (MSK,T∥θ).
Step 3-2: Output ku_{T}={(θ, s_{T∥θ})}_{θ}∈_{KUNode(BT,RL)}.
CSKGen (ssk_{ID}, ku_{T})->csk_{ID,T}
Step 4-1: Select θ∈KUNode(BT,RL)∩Path(ID).
   If such θ does not exist, output ⊥.
Step 4-2: Select k∈_{U}Z_{q}, and set r_{ID,T}=g^{k}.
Step 4-3: Set s_{ID,T}=k+(s_{ID}+s_{T∥θ})H₁(ID∥T, r_{ID,T}).
Step 4-4: Output csk_{ID,T}=(s_{ID,T}, r_{ID,T}, r_{ID}, r_{T∥θ}, θ).
EKGen (csk_{ID,T})->(esk_{ID}, epk_{ID})
Step 5-1: Select V_{Id}∈_{U}Z_{q} and set w_{ID}=g^{v_ID}. Here, “v_ID” represents v_{ID}.
Step 5-2: Output esk_{ID}=v_{ID}, epk_{ID}=(w_{ID}, r_{ID}, r_{T∥θ}, r_{ID,T}, θ.)
SKGen (ID_{A}, ID_{B}, T, csk_{A,T}, esk_{A}, epk_{B})->SK
Step 6-1: Calculate Z₁ by the following equations.

$${Z}_{1} = {( {w}_{B} \cdot {r}_{B , T} \cdot {Y}_{B}^{{H}_{1} ( {ID}_{B} ‖ T , {r}_{B , T} )} )}^{{s}_{A , T} + {v}_{A}} \qquad [ Equation 2 ]$$

$${Y}_{B} = {r}_{B} \cdot {r}_{T ‖ {θ}_{B}} \cdot {y}^{{H}_{1} ( {ID}_{B} , {r}_{B} ) + {H}_{1} ( T ‖ {θ}_{B} , {r}_{T , {θ}_{B}} )} \qquad [ Equation 3 ]$$

Step 6-2: Output SK=H₂(Z₁, Z₂) as Z₂=w_{B}^{v_A}. Here, “v_A” represents v_{A}.

However, as a more secure method, for example, after Z₂ above is calculated, Z₃ may be calculated by the following equation, and SK=H₂(Z₁,Z₂,Z₃) may be output.

$${Z}_{3} = {( {r}_{B , T} \cdot {Y}_{B}^{{H}_{1} ( {ID}_{B} ‖ T , {r}_{B , T} )} )}^{{s}_{A , T}} \qquad [ Equation 4 ]$$

Revoke (RL)
Step 7-1: Output ⊥ if the revoked user list RL_{T} at the current time T is not included in RL.
Step 7-2: Set T<-T+1, and update RL_{T}<-RL if the RL_{T}∈RL.

Here, in step 6-2, for example, the master public key MPK, the IDs of both the initiator and the responder, the time T, and the like may be added as the input of the hash functions H₂ when the session key SK is generated. Specifically, for example, SK=H₂(Z₁,Z₂,MPK,ID_{A},ID_{B},T) or the like may be used, and various other information may be used as the input of the hash function H₂.

<<Flow from Parameter Generation to Static Private key Generation>>

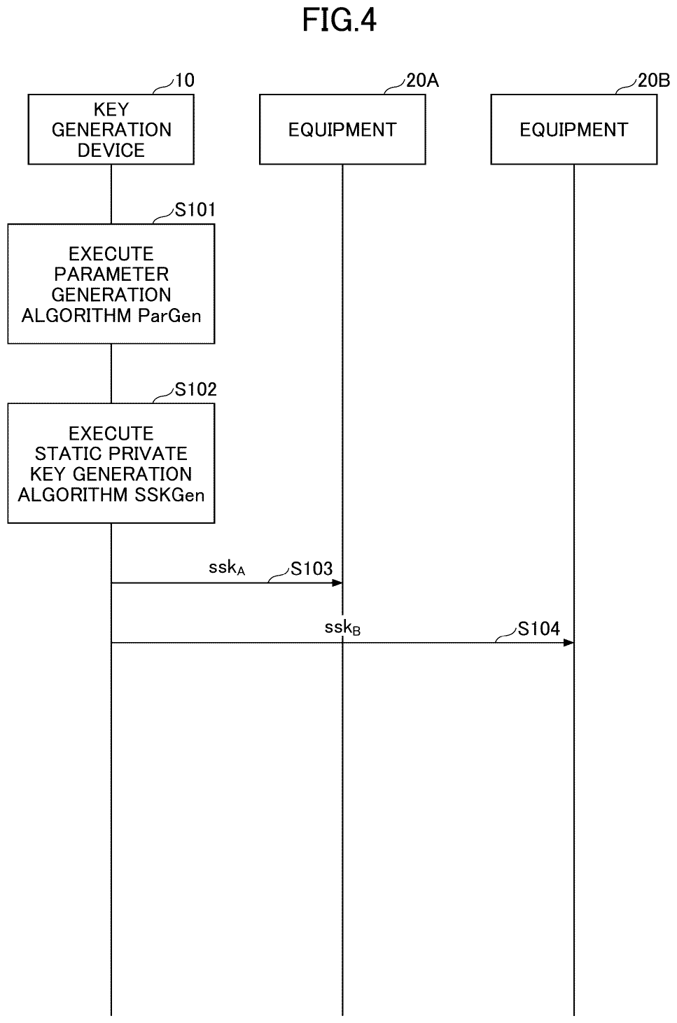

An example of a flow from parameter generation to static private key generation will be described with reference to FIG. 4. Here, the process in FIG. 4 is performed once at the time of the system setup, for example.

The parameter generation unit 101 of the key generation device 10 executes ParGen(1^{λ},N) (step S101). With this, the master private key MSK, the master public key MPK, and the initial revoked user list RL are obtained. Here, the master public key MPK is made public to each equipment 20.

The private key generation unit 102 of the key generation device 10 executes the static private key generation algorithm SSKGen(MSK,ID) (step S102). For example, when the equipment 20A having the identifier ID_{A} and the equipment 20B having the identifier ID_{B} are present, the private key generation unit 102 of the key generation device 10 executes both SSKGen(MSK,ID_{A}) and SSKGen(MSK,ID_{B}). With this, the static private key ssk_{A} of the equipment 20A and the static private key ssk_{B} of the equipment 20B are obtained. The following description assumes that the static private key ssk_{A} and the static private key ssk_{B} have been obtained. It should be noted that the identifier ID is public information.

The communication unit 105 of the key generation device 10 transmits the static private key ssk_{A} to the equipment 20A (step S103). Similarly, the communication unit 105 of the key generation device 10 transmits the static private key ssk_{B} to the equipment 20B (step S104). Here, the static private key ssk_{ID} is transmitted to the equipment 20 through a secure communication path. Alternatively, for example, the static private key ssk_{ID} may be transmitted to the equipment 20 via an external recording medium, or may be transmitted to the equipment 20 by directly connecting to the key generation device 10 through a wired connection.

<<Flow from Revocation List Update to Latest Private key Generation>>

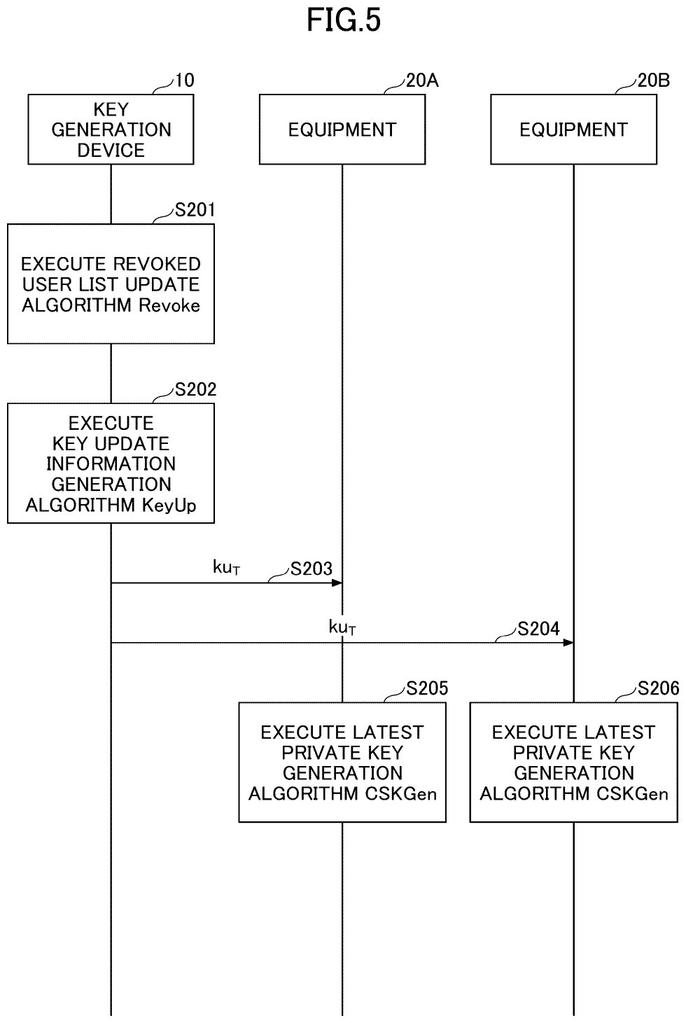

An example of a flow from revocation list update to latest private key generation will be described with reference to FIG. 5. Here, the process in FIG. 5 is repeatedly performed, for example, at regular intervals. Additionally, it is assumed that a new revoked user list RL has been obtained before the process of FIG. 5 is started.

The list update unit 103 of the key generation device 10 executes the revoked user list update algorithm Revoke (RL) (step S201). With this, the current time T is incremented, and the current revoked user list RL_{T} is updated.

The key update information generation unit 104 of the key generation device 10 executes the key update information generation algorithm KeyUp(MSK,T,RL) (step S202). With this, the key update information ku_{T} is obtained.

The communication unit 105 of the key generation device 10 transmits the key update information ku_{T} to the equipment 20A (step S203). Similarly, the communication unit 105 of the key generation device 10 transmits the key update information ku_{T} to the equipment 20B (step S204).

The key update unit 201 of the equipment 20A executes the latest-private key generation algorithm CSKGen(ssk_{A},ku_{T}) (step S205). With this, the latest private key csk_{A,T} of the equipment 20A is obtained. Similarly, the key update unit 201 of the equipment 20B executes the latest-private key generation algorithm CSKGen(ssk_{B},ku_{T}) (step S206). With this, the latest private key csk_{B,T} of the equipment 20B is obtained.

<<Flow from Temporary Key Generation to Session Key Generation>>

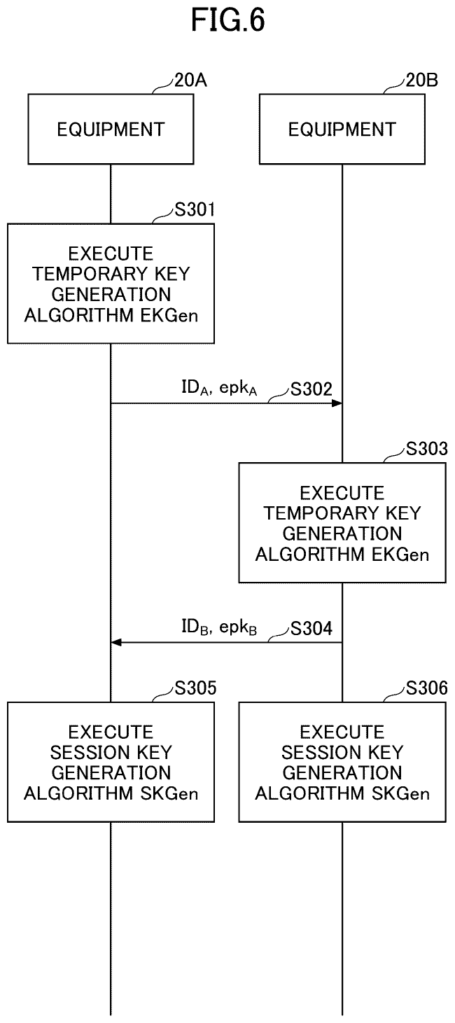

An example of a flow from temporary key generation to session key generation will be described with reference to FIG. 6. Here, the process in FIG. 6 is performed when a session is started between the equipment 20A and the equipment 20B, for example.

The temporary key generation unit 202 of the equipment 20A executes the temporary key generation algorithm EKGen(csk_{A,T}) (step S301). With this, the temporary private key esk_{A} and the temporary public key epk_{A} are obtained.

The communication unit 105 of the equipment 20A transmits its own identifier ID_{A} and the temporary public key epk_{A} to the equipment 20B (step S302).

The temporary key generation unit 202 of the equipment 20B executes the temporary key generation algorithm EKGen(csk_{B,T}) (step S303). With this, the temporary private key esk_{B} and the temporary public key epk_{B} are obtained.

The communication unit 105 of the equipment 20B transmits its own identifier ID_{B} and the temporary public key epk_{B} to the equipment 20A (step S304).

The session key generation unit 203 of the equipment 20A executes the session key generation algorithm SKGen(ID_{A},ID_{B},T,csk_{A,T},esk_{A},epk_{B}) (step S305). With this, the session key SK is obtained.

The session key generation unit 203 of the equipment 20B executes the session key generation algorithm SKGen(ID_{B},ID_{A},T,csk_{B,T},esk_{B},epk_{A}) (step S306). With this, the session key SK is obtained.

### Second Embodiment

In the following, a second embodiment will be described.

In the present embodiment, the configurations of the latest-private key generation algorithm CSKGen, the temporary key generation algorithm EKGen, and the session key generation algorithm SKGen among the algorithms of the ID-based AKE protocol with the revocation function described in the first embodiment are changed. The other points are substantially the same as those of the first embodiment, and therefore, only the changed points will be described below.
CSKGen(ssk_{ID},ku_{T})->csk_{ID,T}
Step 4′-1: Select θ∈KUNode(BT,RL)∩Path(ID).
If such θ does not exist, ⊥ is output.
Step 4′-2: Select k∈_{U}Z_{q} and set r_{ID,T}=g^{k}.
Step 4′-3: Select α,β∈_{U}Z_{q}.
Step 4′-4: Set s_{ID,T}=k+(α·s_{ID}+β·s_{T∥θ})H₁(ID∥T, r_{ID,T}).
Step 4′-5: Output csk_{ID,T}=(s_{ID,T}, r_{ID,T}, r_{ID}, r_{T∥θ}, r_{ID}^{α}, r_{T∥θ}^{β}, y^{α}, y^{β},θ)
EKGen (csk_{ID,T})->(esk_{ID}, epk_{ID})
Step 5′-1: Select V_{Id}∈_{U}Z_{q} and set w_{ID}=g^{v_ID}. Here, “v_ID” represents v_{ID}.
Step 5′-2: Output esk_{ID}=v_{ID}, epk_{ID}=(w_{ID}, r_{ID}, r_{T∥θ}, r_{ID,T}, r_{ID}^{α}, r_{T∥θ}^{β}, y^{α}, y^{β},θ).
SKGen (ID_{A}, ID_{B}, T, csk_{A,T}, esk_{A}, epk_{B})->SK
Step 6′-1: Calculate Z₁ by the following equations.

$${Z}_{1} = {( {w}_{B} \cdot {r}_{B , T} \cdot {Y}_{B}^{{H}_{1} ( {ID}_{B} ‖ T , {r}_{B , T} )} )}^{{s}_{A , T} + {v}_{A}} \qquad [ Equation 5 ]$$

$${Y}_{B} = {r}_{B}^{α} \cdot {r}_{T ‖ {θ}_{B}}^{β} \cdot {y}^{α \cdot {H}_{1} ( {ID}_{B} , {r}_{B} )} \cdot {y}^{β \cdot {H}_{1} ( T ‖ {θ}_{B} , {r}_{T , {θ}_{B}} )} \qquad [ Equation 6 ]$$

Step 6′-2: Output SK=H₂ (Z₁, Z₂) as Z₂=w_{B}^{v_A}. Here, “v_A” represents v_{A}.

However, as a more secure method, for example, after Z₂ is calculated, Z₃ may be calculated by the following equation, and SK=H₂(Z₁, Z₂, Z₃) may be output.

$${Z}_{3} = {( {r}_{B , T} \cdot {Y}_{B}^{{H}_{1} ( {ID}_{B} ‖ T , {r}_{B , T} )} )}^{{s}_{A , T}} \qquad [ Equation 7 ]$$

The substantial difference between the present embodiment and the first embodiment is the fourth step (step 4-4 and step 4′-4) of the latest-private key generation algorithm CSKGen. In step 4-4 of the first embodiment, the Schnorr signature is executed using the sum of s_{ID} and s_{T∥θ} as the signature key, but in step 4′-4 of the present embodiment, a linear combination of s_{ID} and s_{T∥θ} is used as the signature key.

### <Hardware Configuration Example>

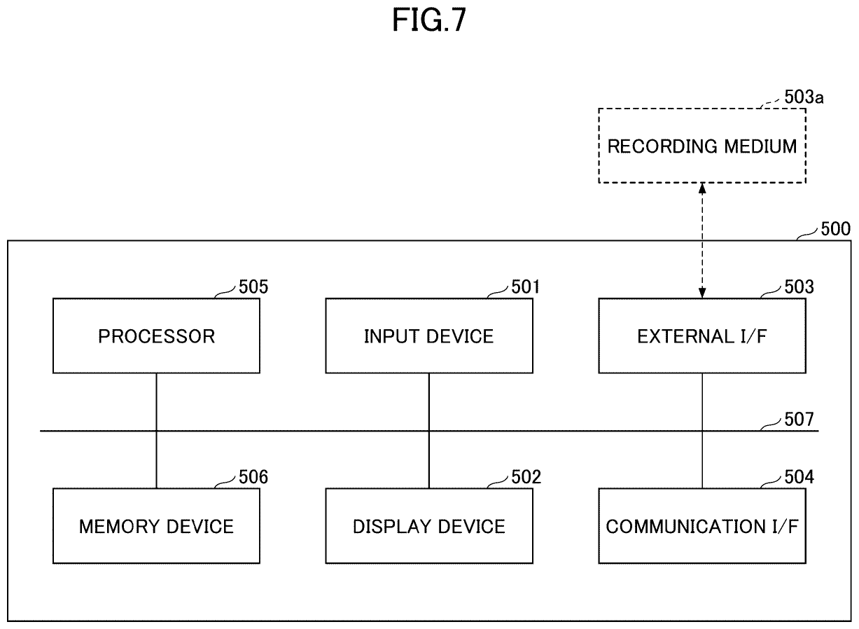

The key generation device 10 and the equipment 20 according to the present embodiment are implemented by, for example, a hardware configuration of a computer 500 as illustrated in FIG. 7. FIG. 7 is a diagram illustrating an example of the hardware configuration of the computer 500.

The computer 500 illustrated in FIG. 7 includes an input device 501, a display device 502, an external I/F 503, a communication I/F 504, a processor 505, and a memory device 506. These hardware components are communicably connected to each other via a bus 507.

The input device 501 is, for example, a keyboard and a mouse, a touch panel, various physical buttons, a switch, or the like. The display device 502 is, for example, a display, a display panel, or the like. Here, the computer 500 need not include at least one of the input device 501 or the display device 502, for example.

The external I/F 503 is an interface with an external device, such as a recording medium 503a. Examples of the recording medium 503a include a compact disc (CD), a digital versatile disk (DVD), a secure digital (SD) memory card, and a universal serial bus (USB) memory card.

The communication I/F 504 is an interface for connecting to a communication network. The processor 505 is various arithmetic devices, such as a CPU. The memory device 506 is, for example, various storage devices, such as an HDD, an SSD, a random access memory (RAM), a read only memory (ROM), and a flash memory.

The key generation device 10 and the equipment 20 according to the present embodiment can be implemented by, for example, the hardware configuration of the computer 500 as illustrated in FIG. 7. However, it is needless to say that the hardware configuration of the computer 500 illustrated in FIG. 7 is an example. The computer 500 illustrated in FIG. 7 may include, for example, multiple processors 505, multiple memory devices 506, and various hardware devices, which are not illustrated.

### SUMMARY

As described above, the ID-based authentication key exchange system 1 according to the present embodiment realizes the key update information generation algorithm KeyUp of the ID-based AKE protocol with the revocation function by using the KUNode algorithm. With this, the time required to generate the key update information does not depend on the number of users, thereby efficiently generating the key update information even in large-scale operation.

Additionally, the ID-based authentication key exchange system 1 according to the present embodiment realizes the latest-private key generation algorithm CSKGen of the ID-based AKE protocol with the revocation function by using the Schnorr signature. With this, the latest private key can be generated by calculation with a relatively low calculation (scalar multiplication, multiplication, or the like on a group) cost without using pairing calculation.

Therefore, according to the ID-based authentication key exchange system 1 of the present embodiment, the ID-based AKE protocol with the revocation function in which the time required to generate key update information does not depend on the number of users and pairing calculation is not required can be realized.

The present invention is not limited to the above-described embodiments specifically disclosed, and various modifications, changes, combinations with known techniques, and the like can be made without departing from the claims.

This application is based on a basic application No. 2022-041306 filed in Japan on Mar. 16, 2022, the entire contents of which are incorporated herein by reference.

### REFERENCES

Reference 1: Alexandra Boldyreva, Vipul Goyal, Virendra Kumar. “Identity-Based Encryption with Efficient Revocation”, 2008.
Reference 2: Jae Hong Seo and Keita Emura. “Revocable Identity-Based Encryption Revisited: Security Model and Construction”, 2013.
Reference 3: Xuecheng Ma and Dongdai Lin. “A Generic Construction of Revocable Identity-Based Encryption”, 2019.

### DESCRIPTION OF REFERENCE SYMBOLS

1 ID-based authentication key exchange system
10 key generation device
20 equipment
30 communication network
101 parameter generation unit
102 private key generation unit
103 list update unit
104 key update information generation unit
105 communication unit
106 storage unit
201 key update unit
202 temporary key generation unit
203 session key generation unit
204 communication unit
205 storage unit

1. An authentication key exchange system comprising:
a key generation device; and
a plurality of equipment,
wherein the key generation device includes:
a first processor; and
a first memory storing program instructions that cause the first processor to:
receive a security parameter^{λ} and a total number N of the equipment as inputs, and output a master private key MSK, a master public key MPK, and an initial revoked user list RL;
receive the master private key MSK, the master public key MPK, and an identifier ID of the equipment as inputs, and output a static private key ssk_{ID} corresponding to the identifier ID;
receive the master public key MPK and a new revoked user list RL as inputs, increment a current time T, and update a revoked user list RL_{T} at the current time T to the revoked user list RL; and
receive the master private key MSK, the master public key MPK, the current time T, and the revoked user list RL as inputs, and output key update information ku_{T} at the current time T by using a KUNode algorithm, and
wherein the equipment includes:
a second processor; and
a second memory storing program instructions that cause the second processor to:
receive the master public key MPK, the static private key ssk_{ID} corresponding to its own identifier ID, and the key update information ku_{T} at the current time T as inputs, and output a latest private key csk_{ID,T} at the current time T without using pairing calculation;
receive the master public key MPK and the latest private key csk_{ID,T} corresponding to its own identifier ID at the current time T as inputs, and output a temporary private key esk_{ID} and a temporary public key epk_{ID}; and
receive the master public key MPK, its own identifier ID, an identifier ID′ of a communication partner, the latest private key csk_{ID,T} corresponding to its own identifier ID at the current time T, the temporary private key esk_{ID} corresponding to its own identifier ID, and a temporary public key epk_{ID′} corresponding to the identifier ID′ of the communication partner as inputs, and output a session key SK shared with the communication partner.

2. The authentication key exchange system as claimed in claim 1, wherein the program instructions cause the second processor to receive the master public key MPK, the static private key ssk_{ID}, and the key update information ku_{T} as the inputs, and output the latest private key csk_{ID,T} by using a Schnorr signature.

3. The authentication key exchange system as claimed in claim 2, wherein the program instructions cause the second processor to output the latest private key csk_{ID,T} by providing a signature to a hash value of information including the identifier ID and the current time T by using the Schnorr signature that uses, as a signature key, a sum or a linear combination of a value s_{ID} included in the static private key ssk_{ID} and a value s_{T∥θ} corresponding to a value θ uniquely determined based on its own identifier ID among a plurality of values s_{T∥θ} included in the key update information ku_{T}.

4. Equipment sharing a session key with another equipment that is a communication partner, the equipment comprising:
a processor; and
a memory storing program instructions that cause the processor to:
receive a master public key MPK, a static private key ssk_{ID} corresponding to its own identifier ID, and key update information ku_{T} at a current time T as inputs, and output a latest private key csk_{ID,T} at the current time T without using pairing calculation;
receive the master public key MPK and the latest private key csk_{ID,T} corresponding to its own identifier ID at the current time T as inputs, and output a temporary private key esk_{ID} and a temporary public key epk_{ID}; and
receive the master public key MPK, its own identifier ID, an identifier ID′ of the communication partner, the latest private key csk_{ID,T} corresponding to its own identifier ID at the current time T, the temporary private key esk_{ID} corresponding to its own identifier ID, and a temporary public key epk_{ID′} corresponding to the identifier ID′ of the communication partner as inputs, and output a session key SK shared with the communication partner.

5. A server that functions as a key generation device, comprising:
a processor; and
a memory storing program instructions that cause the processor to:
receive a security parameter 1^{λ} and a total number N of equipment as inputs, and output a master private key MSK, a master public key MPK, and an initial revoked user list RL;
receive the master private key MSK, the master public key MPK, and an identifier ID of the equipment as inputs, and output a static private key ssk_{ID} corresponding to the identifier ID;
receive the master public key MPK and a new revoked user list RL as inputs, increment a current time T, and update a revoked user list RL_{T} at the current time T to the revoked user list RL; and
receive the master private key MSK, the master public key MPK, the current time T, and the revoked user list RL as inputs, and output key update information ku_{T} at the current time T by using a KUNode algorithm.

6. An authentication key exchange method used by an authentication key exchange system including a key generation device and a plurality of equipment, the authentication key exchange method comprising:
receiving, by the key generation device, a security parameter 1^{λ} and a total number N of the equipment as inputs, and outputting a master private key MSK, a master public key MPK, and an initial revoked user list RL;
receiving, by the key generation device, the master private key MSK, the master public key MPK, and an identifier ID of the equipment as inputs, and outputting a static private key ssk_{ID} corresponding to the identifier ID;
receiving, by the key generation device, the master public key MPK and a new revoked user list RL as inputs, increment a current time T, and updating a revoked user list RL_{T} at the current time T to the revoked user list RL; and
receiving, by the key generation device, the master private key MSK, the master public key MPK, the current time T, and the revoked user list RL as inputs, and outputting key update information ku_{T} at the current time T by using a KUNode algorithm,
receiving, by the equipment, the master public key MPK, the static private key ssk_{ID} corresponding to its own identifier ID, and the key update information ku_{T} at the current time T as inputs, and outputting a latest private key csk_{ID,T} at the current time T without using pairing calculation;
receiving, by the equipment, the master public key MPK and the latest private key csk_{ID,T} corresponding to its own identifier ID at the current time T as inputs, and outputting a temporary private key esk_{ID} and a temporary public key epk_{ID}; and
receiving, by the equipment, the master public key MPK, its own identifier ID, an identifier ID′ of a communication partner, the latest private key csk_{ID,T} corresponding to its own identifier ID at the current time T, the temporary private key esk_{ID} corresponding to its own identifier ID, and a temporary public key epk_{ID′} corresponding to the identifier ID′ of the communication partner as inputs, and outputting a session key SK shared with the communication partner.

7. A non-transitory computer-readable recording medium having stored therein a program for causing a computer to perform the authentication key exchange method as claimed in claim 6.
